(19) United States
(12) Patent Application Publication
(10) Pub. No.: US 2009/0060286 A1
(43) Pub. Date: Mar. 5, 2009

(54) IDENTIFICATION SYSTEM AND METHOD UTILIZING IRIS IMAGING

(75) Inventors: Frederick Wilson Wheeler, Niskayuna, NY (US); Ambalangoda Gurunnanselage Amitha Perera, Clifton Park, NY (US); Gil Abramovich, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/849,541

(22) Filed: Sep. 4, 2007

(51) Int. Cl. G06K 9/00

(52) U.S. Cl. 382/117

(57) ABSTRACT

A biometric identification system and method are provided. The system includes an image capture mechanism for capturing multiple images of a person's iris, a registration component for registering a portion of each image attributable to the iris, and a super-resolution processing component for producing a higher resolution image of the iris. The method includes capturing multiple images of a person's iris, registering a portion of each image attributable to the iris, and applying super-resolution processing to the images to produce a higher-resolution image of the iris.

### BACKGROUND

The invention relates generally to a system and method for identifying a person, and more particularly to a system and method for using iris identification to identify a person.

Systems and methods that can allow for the identification of a person at a distance have a wide array of applications. Such systems can be used to improve current access control systems, for example. One such known system selects a single iris image from a near infrared video stream for use in identification.

There are disadvantages to such a system. One disadvantage is that such a system requires a compliant person, i.e., one willing to submit to iris capture. Further, such a system requires a close-up capture of the single iris image. Additionally, since a single iris image is being used, extra light is necessary to ensure a clear iris image. Another disadvantage is that the use of a single iris image, no matter how clear the image, is constrained by the information within that single image.

It would thus be desirable to provide a system and a method for identifying a person at a distance, using iris capture, that improves over one or more of the aforementioned disadvantages.

### BRIEF DESCRIPTION OF THE DRAWINGS

FIG. 1 is a schematic illustration of a biometric identification system in accordance with an embodiment of the invention.

FIG. 2 is a series of iris images illustrating eyelash motion between images.

FIG. 3 illustrates iris motion in a camera image plane, due to iris movement and/or camera movement, leading to motion blur.

FIG. 4 illustrates an increase of depth of field without affecting recognition performance, due to the use of super-resolution.

FIG. 5 illustrates depth-of-field as a function of aperture diameter.

FIG. 6 illustrates, respectively, (a) depth-of-field versus aperture diameter, (b) exposure time versus aperture diameter, and (c) blur amount versus exposure time.

FIG. 7 illustrates process steps for obtaining a super-resolved image of an iris.

### SUMMARY

The present invention describes a biometric identification system that includes an image capture mechanism for capturing multiple images of a person's iris, a registration component for registering a portion of each image attributable to the iris, and a super-resolution processing component for producing a higher resolution image of the iris.

Another exemplary embodiment of the invention is an identification method that includes capturing multiple images of a person's iris, registering a portion of each image attributable to the iris, and applying super-resolution processing to the images to produce a higher-resolution image of the iris.

Another exemplary embodiment of the invention is a method for controlling access that includes obtaining multiple images of a person's iris and segmenting the iris in each of the multiple images from the non-iris portions. The method further includes registering each iris image, preparing a super-resolved image of the iris and comparing the super-resolved image of the iris to iris images in a database of iris images to ascertain whether there is a match.

These and other advantages and features will be more readily understood from the following detailed description of preferred embodiments of the invention that is provided in connection with the accompanying drawings.

### DETAILED DESCRIPTION OF EXEMPLARY EMBODIMENTS

Embodiments of the invention, as described and illustrated herein, are directed to a system and a methodology that are related to multi-frame iris registration and super-resolution to obtain, at greater standoff distances, a higher-resolution iris image.

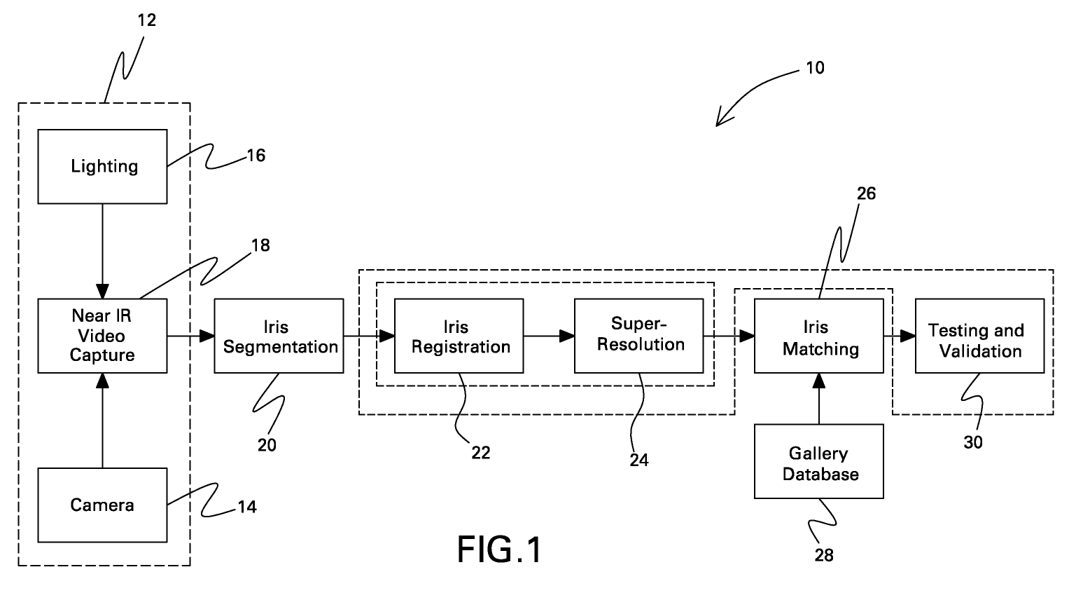

With specific reference to FIG. 1, there is shown a biometric identification system 10 for capturing images of an iris of a person, super-resolving images of the iris into a super-resolved iris image, and matching that iris to an iris image from a database of iris images. The biometric identification system 10 includes an image capture mechanism 12, an iris detecting and segmenting component 20, a registration component 22, a super-resolution processing component 24, and an iris matching component 26.

The image capture mechanism 12 includes three components. The first component, a camera system 14, is used to obtain multiple images of an iris of an individual. It should be understood that the camera system 14 includes at least one digital still or video camera, and may include multiple digital still and/or video cameras. The multiple images of the iris are obtained by positioning the individual, or adjusting the position and focus of the camera system 14, in such a way that his iris comes into or passes through a capture volume location. The camera system 14 obtains the multiple images of the iris when in the capture volume location, which is a location in space in which a camera can image a well-focused iris. As the individual moves out of the capture volume location, the image of the iris either loses focus or moves off the sensor. The capture volume location may be designed such that the individual comes to an access portal and looks in a particular direction, or instead the individual may be shunted along a pathway in which the camera system 14 is taking images.

The capture volume location is one that may be provided with lighting 16. Further, the capture volume location is one at which the iris is illuminated with near infrared (NIR) light, either from an illumination device or from ambient illumination, to allow for NIR video capture of the iris.

Upon capture of the multiple images of the iris, the images are subjected to the iris detecting and segmenting component 20. The iris may be located anywhere within an image. Iris segmentation is the process of finding the iris in each specific image and accurately delimiting its boundaries, including the inner pupil boundary, the outer sclera boundary, and the eyelid boundaries if they occlude the iris. The iris boundaries may be determined using, for example, the NIST Biometric Experimentation Environment software. Such software may also be capable of locating the eyelids and specular reflections.

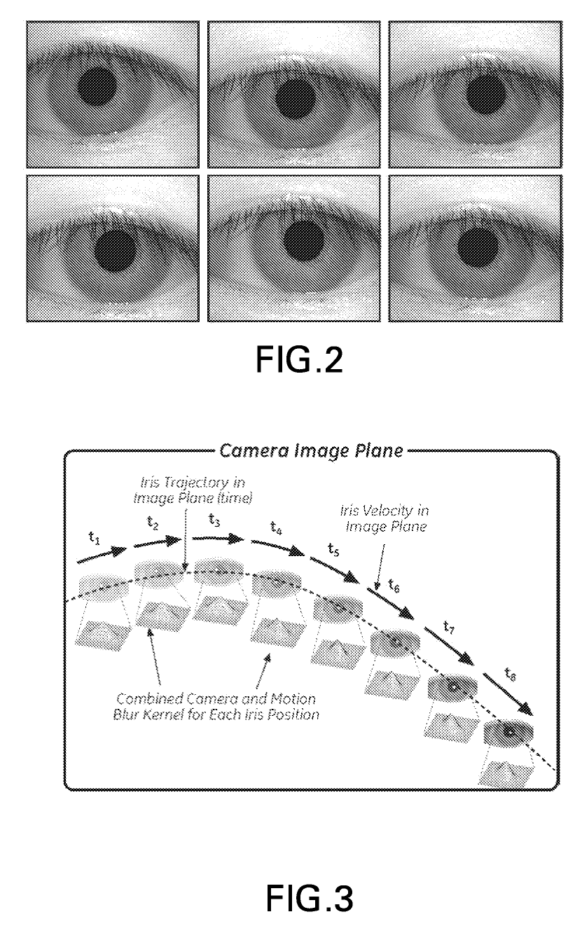

A mask is then created to mark the iris pixels that are visible and not corrupted by such occlusions. Eyelashes and specular reflections can occlude part of the iris and hurt recognition performance. Existing iris recognition systems detect eyelashes and specular reflections and mask them out so that occluded regions of the iris do not contribute to the later matching process. Since a series of iris frames are processed, subject motion will likely inhibit any given portion of the iris being occluded in all the frames. FIG. 2 illustrates how eyelashes can move relative to the iris.

The occlusion mask for each iris image frame will change over time as the occlusions move. The mask may be a binary mask, with 0 for an occluded pixel and 1 otherwise, or it may be continuous with values between 0 and 1 indicating confidence levels as to whether or not the pixel is occluded. Such a mask may be used in a data fidelity part of the super-resolution cost function, to ensure that the only valid iris pixels participate in the super-resolution process. Thus, the masked portions of any frame will not contribute to the solution, but super-resolution processing still will be able to solve for the entire, or almost the entire, exposed iris.

After the creation of the mask on all the images of the irises, each iris is then registered in the registration component 22. Registration of each iris image across multiple image frames is necessary to allow for a later super-resolution of the iris. An accurate registration requires a registration function that maps the pixel coordinates of any point on the iris in one image to the coordinates for that same point on a second image. Through such a registration function, an entire series of iris frames can be registered using a two-image registration process. For example, by finding the registration function between coordinates in the first image in the series and every other image in the series, all the images can be registered to the coordinates of the first image. For proper super-resolution, sub-pixel accuracy is required for the registration function.

One embodiment of the registration component 22 includes a parameterized registration function capable of accurately modeling the frame-to-frame motion of the object of interest without any additional freedom. Iris registration must account not just for the frame-to-frame motion of the eye in the image plane, but also for possible pupil dilation as the series of frames are captured. Known image registration functions such as homographies or affine mappings are unsuitable since they are not capable of registering the iris with pupil dilation. More generalized registration methods, such as optical flow, are too unconstrained and will not yield the most accurate registration.

One proposed registration function may be in the form:

x₂=h(x₁;A,S),

which maps iris pixel coordinates x₁ in the first image to iris pixel coordinates x₂ on the second image. Conceptually, h can be decomposed as

x₂=h(x₁;A,S)=f(g(x₁;A);S).

In the above function, g is parameterized by vector A, and is a six-parameter affine transform that maps the outer iris boundary of the first image to the outer iris boundary of the second image. Affine transforms are commonly used for image registration and can model the motion of a moving planar surface, including shift, rotation, and skew. Since the outer iris boundary is rigid and planer, an affine transform perfectly captures all the degrees of freedom.

Once the outer boundaries are aligned, f compensates for the motion of the pupil relative to the iris outer boundary by warping the iris as if it were a textured elastic sheet until the pupil in the first image matches the pupil in the second image. This function is parameterized by a six-dimensional vector S encoding the locations and diameters of the pupils in the two images.

Given the image and structure of a registration function, the registration process must solve for the parameters of that function, here A and S. This may be accomplished through the use of non-linear optimization through a cost function such as:

$$J = {\sum }_{x ∈ {I}_{1}} ‖ {I}_{1} ( x ) = {I}_{2} ( h ( x ; A , S ) ) ‖ .$$

Such a cost function is defined to measure how accurately image I₂ matches image I₁ when it has been warped according to the registration function h. Finding the parameters A and S that minimize J completes the iris registration process.

Each individual iris image frame offers limited detail. However, the collection of the image frames taken together can be used to produce a more detailed image of the iris. The goal of super-resolution is to produce a higher-resolution image of the iris that is limited by the camera optics but not the digitization of each frame. Slight changes in pixel sampling, due to slight movements of the person from frame to frame, allows each observed iris image frame to provide additional information. The super-resolved image offers a resolution improvement over that of each individual iris image frame; in other words, whatever the original resolution, the super-resolved image will be some percentage greater resolution. Resolution improvement is not simply the difference between interpolation to a finer sampling grid. Instead, there is a real increase in information content and fine details.

Next will be described the super-resolution processing component 24. Super-resolution yields improvement because there is a noise reduction that comes whenever multiple measurements are combined. Also, there is a high-frequency enhancement from deconvolution similar to that achieved by Wiener filtering or other sharpening filters. Third, super-resolution leads to multi-image de-aliasing, making it possible to recover higher-resolution detail that could not be seen in any of the observed images because it was above the Nyquist bandwidth of those images. Finally, with iris imaging there can be directional motion blur. When the direction of motion causing the motion blur is different in different frames, super-resolution processing can “demultiplex” the differing spatial frequency information from the series of image frames.

When a subject is walking, moving its head, or otherwise moving, or if the camera is moving or settling from movement, there will be some degree of motion blur. Motion blur occurs when the subject or camera is moving during the exposure of a frame. If there is diversity in the directions of iris motion that cause the motion blur, then the motion blur kernel will be different for different iris frames. FIG. 6 illustrates how the iris might move in the image plane as a series of eight iris images are collected. The blur kernels depicted in FIG. 6 reflect the changing velocity and direction of the iris in the image plane.

To determine the motion blur kernels, from iris segmentation the direction and velocity of the motion of the iris on the image plane during the exposure time of each frame is estimated. FIG. 6 illustrates how the blur kernels change in shape and orientation as the iris motion direction changes. When the motion blur kernel orientation varies over time, super-resolution is especially effective at mitigating the motion blur. For example, suppose that a first iris frame has horizontal motion blur and a second iris frame has vertical motion blur. The first iris frame has good resolution in the vertical direction and reduced resolution in the horizontal direction, while the second iris frame has good resolution in the horizontal direction and reduced resolution in the vertical direction. Super-resolution processing combines two such iris frames to produce one frame with better resolution in all directions.

Super-resolution processing works by modeling an image formation process relating the desired but unknown super-resolved image X to each of the known input image frames Yᵢ. The super-resolved image generally has about twice the pixel resolution of the individual input image frames, so that the Nyquist limit does not prevent it from representing the high spatial frequency content that can be recovered. The super-resolution image formation process accounts for iris motion (registration), motion blur, defocus blur, sensor blur, and detector sampling that relate each Yᵢ to X. The super-resolution image formation process can be modeled as:

Yᵢ=DHᵢFᵢX+Vᵢ.

For each input frame Yᵢ, Fᵢ represents the registration operator that warps the super-resolved image that will be solved for X to be aligned with Yᵢ, but at a higher sampling resolution. Hi is the blur operator, incorporating motion blur, defocus blur, and sensor blur into a single point spread function (PSF). D is a sparse matrix that represents the sampling operation of the detector and yields frame Yᵢ. Vᵢ represents additive pixel intensity noise. The above algorithm is described using standard notation from linear algebra. In actual implementation, the solution process is carried out with more practical operations on two-dimensional pixel arrays.

The super-resolved image X is determined by optimizing a cost function that has a data fidelity part and a regularization part. The data fidelity part of the cost function is the norm of the difference between the model of the observations and the actual observations,

$$J ( X ) = {\sum }_{i = 1}^{N} ‖ {DH}_{i} {F}_{i} X - {Y}_{i} ‖ .$$

When a mask image Mᵢ is available for each iris image (as described above), the mask may be incorporated into the data fidelity part as

$$J ( X ) = {\sum }_{i = 1}^{N} ‖ {M}_{i} {DH}_{i} {F}_{i} X - {M}_{i} {Y}_{i} ‖ .$$

Super-resolution is an ill-posed inverse problem. This means that there are actually many solutions to the unknown super-resolved image that, after the image formation process, are consistent with the observed low-resolution images. The reason for this is that very high spatial frequencies are blocked by the optical point spread function, so there is no observation-based constraint to prevent high-frequency noise from appearing in the solution. So, an additional regularization term Ψ(X) is used to inhibit solutions with noise in unobservable high spatial frequencies. For this regularization term, a Bilateral Total Variation function:

$$Ψ ( X ) = {\sum }_{1 = - P}^{P} {\sum }_{m = - P}^{P} {α}^{\vert m \vert + \vert l \vert} ‖ X - {S}_{x}^{l} {S}_{y}^{m} X ‖$$

may be used for the super-resolution process. Here, S^{l}ₓ and S^{m}_{y} are operators that shift the image in the x and y direction and by 1 and m pixels. With Bilateral Total Variation, the neighborhood over which absolute pixel difference constraints are applied can be larger (with P>1) than for Total Variation. The size of the neighborhood is controlled by the parameter P and the constraint strength decay is controlled by α(0<α<1).

To solve for the super-resolved image, X minimizes the total cost function, including the data part and the regularization term,

$$\hat{X} = {arg }_{X} min ( J ( X ) + λΨ ( X ) ) .$$

Here, λ is a scalar weighting factor that controls the strength of the regularization term. The super-resolved image X will be initialized by warping and averaging several of the iris image frames. A steepest descent search using the gradient of the cost function then yields the final result.

Iris matching, such as that performed by the iris matching component 26, is the process of testing an obtained iris image against a set of iris images in a database to determine whether there is a match between any of these images to the obtained iris image. Known systems use a captured iris image against a gallery database, such as the gallery database 28. In an embodiment of the invention, the obtained iris image is the super-resolved image obtained from the super-resolution processing component 24. The iris matching process performed by the iris matching component 26 may use known software implementations, such as, for example, the Masek algorithm. Depending upon the use being made of the biometric identification system 10, a match between the super-resolved iris image and any of the iris images found in the gallery database may lead to access or denial of access. For example, where the gallery database 28 includes iris images of personnel who have been pre-cleared to access a certain location, then a match allows for the access to occur. Where, to the contrary, the gallery database 28 includes iris images of known individuals who are to be denied access, then a match would allow for the access to be denied.

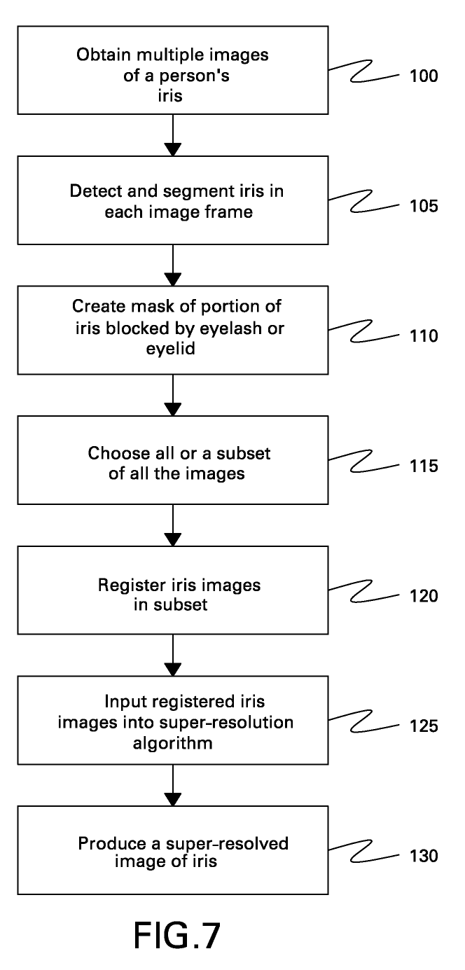

Next, with specific reference to FIG. 7, will be described a process for obtaining a super-resolved image of an iris. At an initial Step 100, multiple images of a person's iris are obtained. As noted with reference to FIG. 1, the multiple images may be captured through the image capture mechanism 12. Then, at Step 105, the iris is detected and segmented in each image frame obtained. This may be accomplished through the detecting and segmenting component 20. At Step 110, a mask is prepared to cover portions of the iris in each frame that are occluded by eyelashes, eyelids and specular reflections. From the images obtained, all of the images or a subset (a subset being all of the images or some smaller sampling of all the images) of all the images is chosen at Step 115. Using the subset of images, the iris images in each of the chosen images is registered at Step 120. The registration of the iris images may be accomplished through the registration component 22. Upon the iris images being registered, at Step 125 the registration data for each of the iris images is submitted to a super-resolution algorithm in the super-resolution processing component 24, which allows for the production of a super-resolved image of the iris at Step 130.

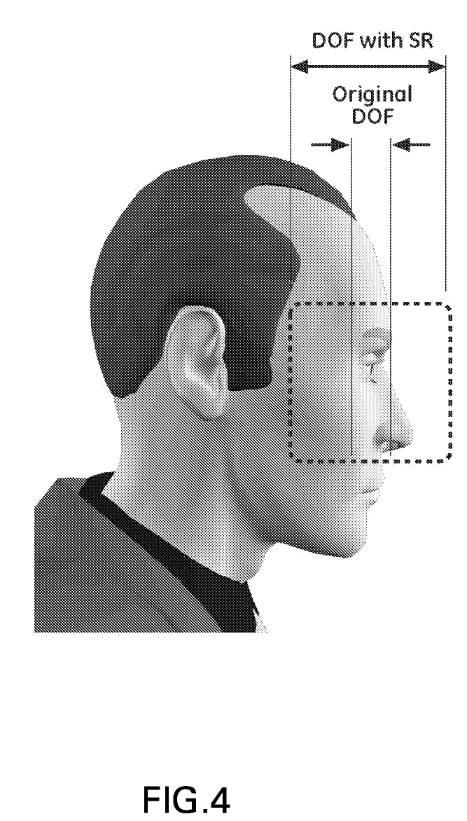

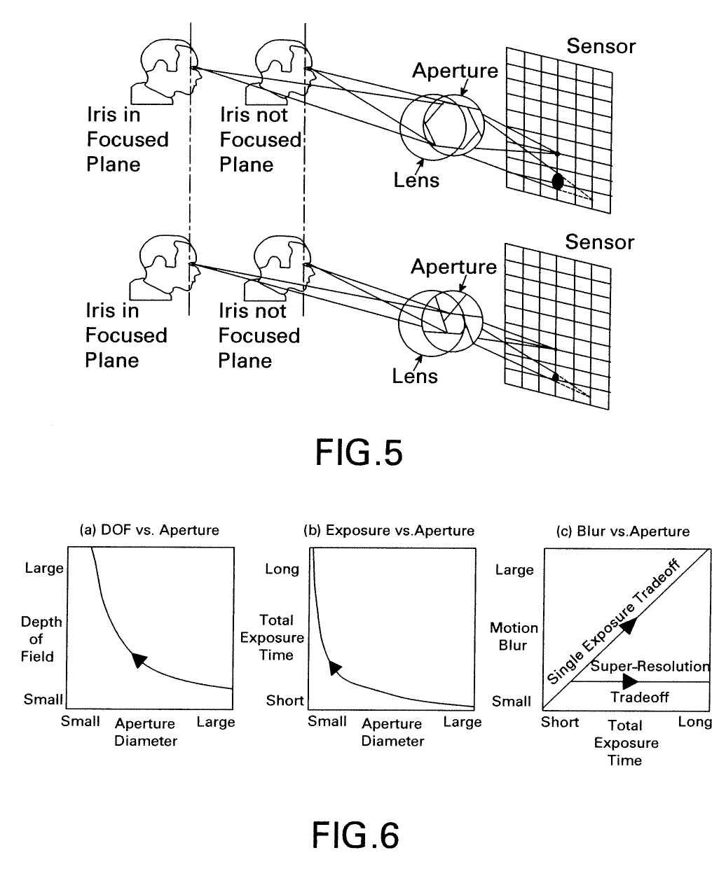

Super-resolution benefits iris recognition by improving iris image quality and thus reducing the false rejection rate for a given low false recognition rate. Further, super-resolution can improve other aspects of the biometric identification system 10. One such improvement is increasing the capture volume by increasing the depth-of-field without sacrificing recognition performance. Depth-of-field (DOF) is the range of distances by which an object may be shifted from the focused plane without exceeding the acceptable blur (FIG. 4). DOF is also a critical parameter affecting the ease of use of an iris capture system. FIG. 5 depicts the tradeoff between acceptable blur, focused plane and aperture diameter.

Increasing DOF makes an iris capture system easier to use. In iris capture systems, DOF is generally small and is responsible for user difficulties. Known iris capture devices can be difficult to use because it is hard to position and hold your eye in the capture volume, specifically, within the DOF. Increasing the DOF will make such systems easier and faster to use, thus increasing throughput. A sufficient DOF in iris recognition should equal or exceed the depth range where the iris may reside during the capture window. As noted by

DOF=2bdfz(f+z)/(d²f²−b²z²),

as the aperture diameter d decreases, the DOF increases. The term b is the allowed blur in the image plane (sensor), f is the lens focal length, and z is the distance between the object and the lens center of projection. FIG. 6 illustrates the various tradeoffs between (a) DOF and aperture diameter, (b) exposure time and aperture diameter, and (c) blur and exposure time. By closing the aperture the DOF can be increased. However, reducing the aperture diameter also reduces the amount of light intensity or irradiance falling on the sensor:

I∝D₂,

where I is the irradiance in energy per unit time per unit area and D is the aperture diameter for a constant focal-length lens.

An additional consideration to DOF is diffraction. Diffraction refers to the interaction between a light wavefront and an aperture. Such an interaction results in imaging any specific infinitesimally small point in focus on the object as a high intensity spot on the sensor, having a finite size, instead of an infinitesimally small point. This spot on the sensor creates an optical resolution limit. Therefore, excessive decrease in aperture diameter may result in an optical resolution below the sensor resolution limit, degrading overall system performance. However, diffraction can be used, in conjunction with an optimal aperture stop selection, to remove high frequency components that are both beyond the Nyquist limit and beyond what can be recovered through de-aliasing from super-resolution. Super-resolution allows for the increase of the DOF by reducing the aperture diameter, the maintenance of the same illumination level, and the production of better quality images without motion blur. Increasing the DOF by a factor of 2, for example, would require extending the exposure time by a factor of 4 for similar irradiance, or using two images with similar exposure time of the original image with half the irradiance falling on the sensor. Doing so results in half the dynamic range and half the signal-to-noise ratio represented in each image. From the two images, a single high quality image is extracted using super-resolution. In this example, the net gain is improving the ease of use of an iris capture system by doubling the depth range where the subject may be positioned without performance deterioration. A similar exercise can be run with four images and one-sixteenth the irradiance level captured in each image.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A biometric identification system, comprising:
an image capture mechanism for capturing multiple images of a person's iris;
a registration component for registering a portion of each image attributable to the iris; and
a super-resolution processing component for producing a higher resolution image of the iris.

2. The system of claim 1, comprising a detecting and segmenting component for detecting and segmenting the iris from non-iris portions within each image.

3. The system of claim 2, comprising a masking component for masking the non-iris portions within each image.

4. The system of claim 1, comprising an iris matching component for comparing the higher resolution image of the iris to a database of iris images.

5. The system of claim 1, wherein the image capture mechanism comprises at least one digital camera.

6. The system of claim 4, wherein the at least one digital camera comprises a video camera.

7. The system of claim 6, wherein said video camera is equipped to capture near infrared images.

8. The system of claim 1, wherein the image capture mechanism comprises a source of near infrared light.

9. The system of claim 1, comprising a linkage with an access portal.

10. An identification method, comprising:
capturing multiple images of a person's iris;
registering a portion of each image attributable to the iris; and
applying super-resolution processing to the images to produce a higher-resolution image of the iris.

11. The method of claim 10, comprising detecting and segmenting the iris from non-iris portions within each of the multiple images.

12. The method of claim 11, comprising masking the non-iris portions within each of the multiple images.

13. The method of claim 12, comprising choosing a subset of the multiple images to submit to said registering a portion of each image attributable to the iris.

14. The method of claim 10, comprising iris matching for comparing the higher-resolution image of the iris to a database of iris images

15. The method of claim 10, wherein said capturing multiple images comprises capturing the multiple images as the iris passes into a capture volume location.

16. The method of claim 15, wherein said capturing multiple images comprises illuminating the iris with a near infrared light.

17. The method of claim 10, wherein said registering a portion of each image attributable to the iris comprises mapping pixel coordinates of any point on the iris in one of the multiple images to respective coordinates of that point on the iris in a second of the multiple images.

18. The method of claim 17, wherein said registering a portion of each image attributable to the iris comprises using a parameterized registration function to model frame-to-frame motion of the iris.

19. The method of claim 10, wherein said applying super-resolution processing comprises:
modeling an image formation process relating to the higher-resolution image to each known input frames; and
accounting for iris motion, motion blur, defocus blur, sensor blur, detector sampling, or any combination thereof.

20. A method for controlling access, comprising:
obtaining multiple images of a person's iris;
segmenting the iris in each of the multiple images from the non-iris portions;
registering each iris image;
preparing a super-resolved image of the iris; and
comparing the super-resolved image of the iris to iris images in a database of iris images to ascertain whether there is a match there between.

21. The method of claim 20, wherein a match between the database of iris images and the super-resolved image allows access to be granted.

22. The method of claim 20, wherein a match between the database of iris images and the super-resolved image allows access to be denied.

23. The method of claim 20, comprising creating a mask of non-iris portions of the obtained multiple images.

24. The method of claim 20, comprising choosing a subset of the obtained multiple images.
